(19) United States
(12) Patent Application Publication
(10) Pub. No.: US 2008/0294396 A1
(43) Pub. Date: Nov. 27, 2008

(54) SYSTEM AND METHOD FOR VALIDATING DESIGN REQUIREMENTS

(76) Inventors: Shingchi Hsu, Cypress, CA (US); Kun Peng, Cypress, CA (US); James Stephens, Renton, WA (US)

Correspondence Address: Siemens Corporation;Intellectual Property Department, 170 Wood Avenue South, Iselin, NJ, 08830, US

(21) Appl. No.: 12/052,677

(22) Filed: Mar. 20, 2008

Related U.S. Application Data
(60) Provisional application No. 60/896,709, filed on Mar. 23, 2007.

(51) Int. Cl. G06F 17/50

(52) U.S. Cl. 703/2

(57) ABSTRACT

A system, method, and computer program for design validation, comprising defining a plurality of requirements; extracting said plurality of requirements; comparing a design against said plurality of requirements; and reporting a result of said comparison, and appropriate means and computer-readable instructions.

### CROSS-REFERENCE TO RELATED APPLICATIONS

This application claims priority to pending Provisional U.S. Application Ser. No. 60/896,709, filed on Mar. 23, 2007, which application is incorporated herein by reference in its entirety.

### TECHNICAL FIELD

The presently preferred embodiment of the innovations described herein relates generally to design requirements. More specifically, the presently preferred embodiment relates to validating design requirements in a design model.

### BACKGROUND

Requirements are commonly used as inputs in the design stage of product development, for example in a FURPS model. Those inputs typically define what is needed in a particular product or service output. Put another way, the requirement describes what a system or product does once developed. A functional specification is the result of describing how the system or product does what it does, once developed. Requirements can be kept in a document format, e.g., Microsoft Word or Excel, or in a database format, e.g., SQL. Next, a design specification is formulated to provide the how-details specific to a particular platform or architecture. While creating the design, for example, a product design using a CAD application like NX® by Siemens Product Lifecycle Management Software Inc., it is important to maintain design characteristics that are within the original requirement specifications. To accomplish this task, the CAD application may have the ability to import the requirement, as Word or Excel or other data, to provide the capability for a design check against the necessary requirements. Problems may arise in the event that requirements change, which have an impact on the product design or when product design constraints necessitate a requirement change in order to comport the realities of the product design with the requirements. In some cases, the issue with requirements themselves may not be readily available, such as being isolated on individual computers with limited access, stored in databases with little resemblance to the product structure, or maintained through complicated user interfaces with significant learning curves.

What is needed is a system and method for product design validation that comports with product structure.

### SUMMARY

To achieve the foregoing, and in accordance with the purpose of the presently preferred embodiment as described herein, the present application provides a method for design validation, comprising defining a plurality of requirements; extracting said plurality of requirements; comparing a design against said plurality of requirements; and reporting a result of said comparison. The method, wherein said defining step is performed in a product data managed environment. The method, wherein said design is a virtual design. The method, further comprising modifying said plurality of requirements from said design. The method, wherein said plurality of requirements is obtained from an external document. The method, wherein said plurality of requirements is obtained from a design application. The method, wherein said reporting step provides a feedback. The method, further comprising modifying said design based on said result step.

An advantage of the presently preferred embodiment is to provide a computer-program product tangibly embodied in a machine readable medium to perform a method for design validation, comprising instructions operable to cause a computer to define a plurality of requirements; extract said plurality of requirements; compare a design against said plurality of requirements; and report a result of said comparison. The product, wherein said defining step is performed in a product data managed environment. The product, wherein said design is a virtual design. The product, further comprising instructions to modify said plurality of requirements from said design. The product, wherein said plurality of requirements is obtained from an external document. The product, wherein said plurality of requirements is obtained from a design application. The product, wherein said reporting step provides a feedback. The product, further comprising instructions to modify said design based on said result step.

Another advantage of the presently preferred embodiment is to provide a data processing system having at least a processor and accessible memory to implement a method for design validation, comprising means for defining a plurality of requirements; means for extracting said plurality of requirements; means for comparing a design against said plurality of requirements; and means for reporting a result of said comparison.

Other advantages of the presently preferred embodiment will be set forth in part in the description and in the drawings that follow, and, in part will be learned by practice of the presently preferred embodiment. The presently preferred embodiment will now be described with reference made to the following Figures that form a part hereof. It is understood that other embodiments may be utilized and changes may be made without departing from the scope of the presently preferred embodiment.

### BRIEF DESCRIPTION OF THE DRAWINGS

A presently preferred embodiment will hereinafter be described in conjunction with the appended drawings, wherein like designations denote like elements, and:

FIG. 1 is a logic flow diagram of the method employed by the presently preferred embodiment;

FIG. 2 illustrates a flow chart of the presently preferred embodiment; and

FIG. 3 is a block diagram of a computer environment in which the presently preferred embodiment may be practiced.

### DETAILED DESCRIPTION OF THE PREFERRED EMBODIMENTS

### Computer System

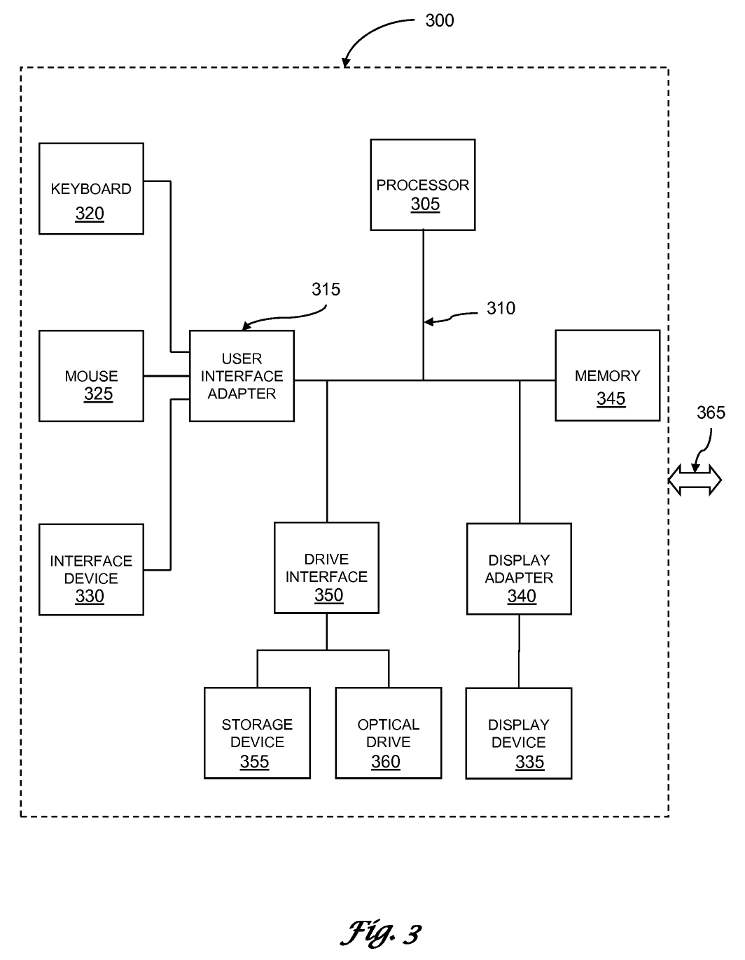

The numerous innovative teachings of the present application will be described with particular reference to the presently preferred embodiments. It should be understood, however, that this class of embodiments provides only a few examples of the many advantageous uses of the innovative teachings herein. The presently preferred embodiment provides, among other things, a system and method for validating design requirements. Now therefore, in accordance with the presently preferred embodiment, an operating system executes on a computer, such as a general-purpose personal computer. FIG. 3 and the following discussion are intended to provide a brief, general description of a suitable computing environment in which the presently preferred embodiment may be implemented. Although not required, the presently preferred embodiment will be described in the general context of computer-executable instructions, such as program modules, being executed by a personal computer. Generally program modules include routines, programs, objects, components, data structures, etc., that perform particular tasks or implement particular abstract data types. The presently preferred embodiment may be performed in any of a variety of known computing environments.

Referring to FIG. 3, an exemplary system for implementing the presently preferred embodiment includes a general-purpose computing device in the form of a computer 300, such as a desktop or laptop computer, including a plurality of related peripheral devices (not depicted). The computer 300 includes a microprocessor 305 and a bus 310 employed to connect and enable communication between the microprocessor 305 and a plurality of components of the computer 300 in accordance with known techniques. The bus 310 may be any of several types of bus structures including a memory bus or memory controller, a peripheral bus, and a local bus using any of a variety of bus architectures. The computer 300 typically includes a user interface adapter 315, which connects the microprocessor 305 via the bus 310 to one or more interface devices, such as a keyboard 320, mouse 325, and/or other interface devices 330, which can be any user interface device, such as a touch sensitive screen, digitized pen entry pad, etc. The bus 310 also connects a display device 335, such as an LCD screen or monitor, to the microprocessor 305 via a display adapter 340. The bus 310 also connects the microprocessor 305 to a memory 345, which can include ROM, RAM, etc.

The computer 300 further includes a drive interface 350 that couples at least one storage device 355 and/or at least one optical drive 360 to the bus. The storage device 355 can include a hard disk drive, not shown, for reading and writing to a disk, a magnetic disk drive, not shown, for reading from or writing to a removable magnetic disk drive. Likewise the optical drive 360 can include an optical disk drive, not shown, for reading from or writing to a removable optical disk such as a CD ROM or other optical media. The aforementioned drives and associated computer-readable media provide non-volatile storage of computer readable instructions, data structures, program modules, and other data for the computer 300.

The computer 300 can communicate via a communications channel 365 with other computers or networks of computers. The computer 300 may be associated with such other computers in a local area network (LAN) or a wide area network (WAN), or it can be a client in a client/server arrangement with another computer, etc. Furthermore, the presently preferred embodiment may also be practiced in distributed computing environments where tasks are performed by remote processing devices that are linked through a communications network. In a distributed computing environment, program modules may be located in both local and remote memory storage devices. All of these configurations, as well as the appropriate communications hardware and software, are known in the art.

Software programming code that embodies the presently preferred embodiment is typically stored in the memory 345 of the computer 300. In the client/server arrangement, such software programming code may be stored with memory associated with a server. The software programming code may also be embodied on any of a variety of non-volatile data storage device, such as a hard-drive, a diskette or a CD-ROM. The code may be distributed on such media, or may be distributed to users from the memory of one computer system over a network of some type to other computer systems for use by users of such other systems. The techniques and methods for embodying software program code on physical media and/or distributing software code via networks are well known and will not be further discussed herein.

### Design Validation

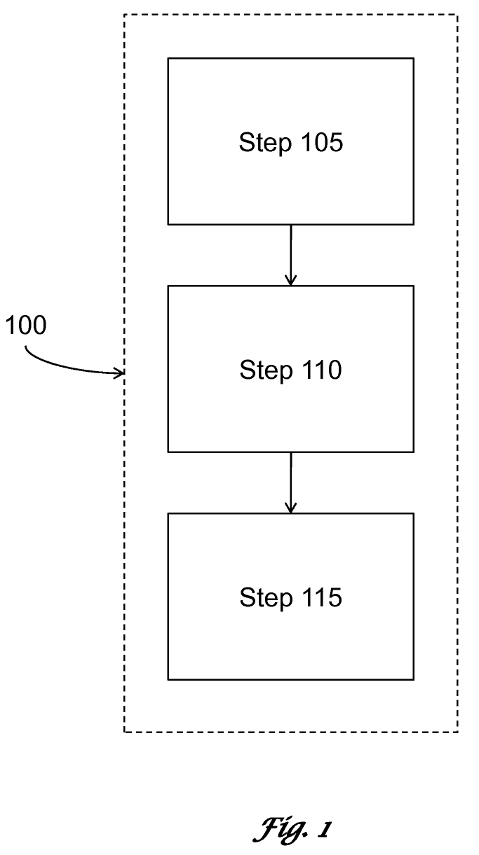

FIG. 1 is a logic flow diagram of the method employed by the presently preferred embodiment. Referring to FIG. 1, the presently preferred embodiment provides a method for product design validation 100 that begins with defining requirements in a product data managed (PDM) environment (Step 105). The next step involves extracting the requirements from the PDM environment (Step 110). Then, validating the extracted requirements against a product design (Step 115), so that the presently preferred embodiment aligns the extracted requirements to the product design. The methods of product design validation in accordance with the presently preferred embodiment are set forth in more detail below.

### Step 1

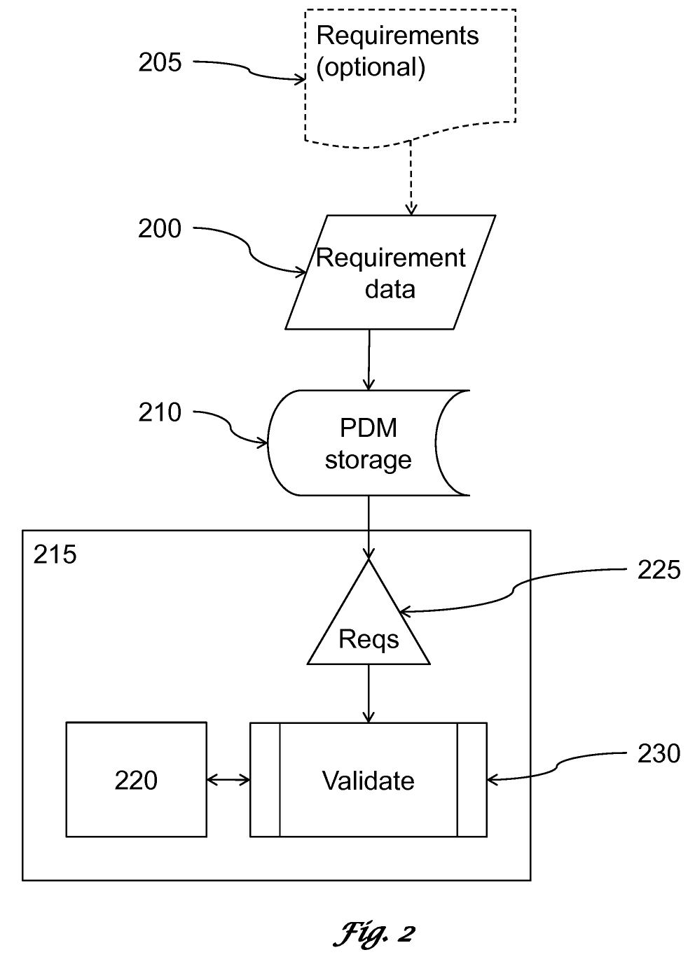

FIG. 2 illustrates a flow chart of the presently preferred embodiment. Referring to FIG. 2, a set of requirement data 200 is entered into a PDM environment like Teamcenter® sold by Siemens Product Lifecycle Management Software, Inc. by any method known to enter data, e.g., by extracting information from an external requirements document 205 created by Word or Excel. Alternatively, the set of requirement data 200 can be directly entered in the PDM environment using provided tools by a design application. The requirements necessary for product development are now defined in the PDM environment (Step 105) in a PDM storage location 210, for use by a down-stream process.

### Step 2

Continuing further with FIG. 2, the down-stream process may include creation of product components by a design application that is preferably a CAD application 215 like NX® sold commercially by Siemens Product Lifecycle Management Software, Inc. A designer initiates the CAD application 215 and associates a product design 220 with the set of requirement data 200 stored in the PDM storage location 210. The association of the product design 220 to the set of requirement data 200 occurs by methods known in the art, for example, selecting a file or data location from a drop-down selection or entering the location in a text box. Regardless, as the designer models the various product components in an attempt to satisfy the product design 220 with the set of requirement data 200, the designer initiates a validate command 230 in the CAD application 215 using commonly known techniques. The CAD application 215 preferably extracts, at 225, the set of requirement data 200 from the PDM storage location 210 (Step 110). The extraction step can occur any number of ways, but will preferably utilize Service-Oriented Architecture (SOA) functions that return data in PLMXML format for Teamcenter objects, where PLMXML is a known and well document standard such that further discussion is not required.

### Step 3

Continuing with FIG. 2, following the extraction 225, a number of values in the product design 220 are compared with the set of requirement data 200 to satisfy compliance with an overall design intent as defined by the set of requirement data 200 (Step 115). It is understood that requirement data can come from a variety of sources, and may preferably consist of industry or other standards, e.g., ergonomic criteria. The product design 220 will either pass or fail the test of whether the product design 200 satisfies the set of requirement data 200. At that time, error clues will alert the designer to a failed component or a passed component as defined by the set of requirement data 200. Alternatively, the designer may alter the set of requirement data 200 to comport with actual design condition, for example, a component is too large for a particular vessel and will therefore not perform as defined in the set of requirement data 200. The designer could initiate an alternate for the product design 220 that would be propagated to the set of requirement data 200 or the external requirement document 205, or alternatively kept in the PDM storage location 210. The designer initiated change would then follow standard approval processes, for example.

### CONCLUSION

From Step 1 through Step 3, the presently preferred embodiment has disclosed a complete solution for validating design requirements. The presently preferred embodiment may be implemented in digital electronic circuitry, or in computer hardware, firmware, software, or in combinations thereof. An apparatus of the presently preferred embodiment may be implemented in a computer program product tangibly embodied in a machine-readable storage device for execution by a programmable processor; and method steps of the presently preferred embodiment may be performed by a programmable processor executing a program of instructions to perform functions of the presently preferred embodiment by operating on input data and generating output.

The presently preferred embodiment may advantageously be implemented in one or more computer programs that are executable on a programmable system including at least one programmable processor coupled to receive data and instructions from, and to transmit data and instructions to, a data storage system, at least one input device, and at least one output device. The application program may be implemented in a high-level procedural or object-oriented programming language, or in assembly or machine language if desired; and in any case, the language may be an assembled, compiled or interpreted language.

Generally, a processor will receive instructions and data from a read-only memory and/or a random access memory. Storage devices suitable for tangibly embodying computer program instructions and data include all forms of nonvolatile memory, including by way of example semiconductor memory devices, such as EPROM, EEPROM, and flash memory devices; magnetic disks such as internal hard disks and removable disks; magneto-optical disks; and CD-ROM disks. Any of the foregoing may be supplemented by, or incorporated in, specially-designed ASICs (application2-specific integrated circuits).

A number of embodiments have been described. It will be understood that various modifications may be made without departing from the spirit and scope of the presently preferred embodiment. Therefore, other implementations are within the scope of the following claims.

What is claimed is:

1. A method for design validation, comprising:
defining a plurality of requirements;
extracting said plurality of requirements;
comparing a design against said plurality of requirements; and
reporting a result of said comparison.

2. The method of claim 1, wherein said defining step is performed in a product data managed environment.

3. The method of claim 1, wherein said design is a virtual design.

4. The method of claim 1, further comprising modifying said plurality of requirements from said design.

5. The method of claim 1, wherein said plurality of requirements is obtained from an external document.

6. The method of claim 1, wherein said plurality of requirements is obtained from a design application.

7. The method of claim 1, wherein said reporting step provides a feedback.

8. The method of claim 1, further comprising modifying said design based on said result step.

9. A computer-program product tangibly embodied in a machine readable medium to perform a method for design validation, comprising instructions operable to cause a computer to:
define a plurality of requirements;
extract said plurality of requirements;
compare a design against said plurality of requirements; and
report a result of said comparison.

10. The product of claim 9, wherein said defining step is performed in a product data managed environment.

11. The product of claim 9, wherein said design is a virtual design.

12. The product of claim 9, further comprising instructions to modify said plurality of requirements from said design.

13. The product of claim 9, wherein said plurality of requirements is obtained from an external document.

14. The product of claim 9, wherein said plurality of requirements is obtained from a design application.

15. The product of claim 9, wherein said reporting step provides a feedback.

16. The product of claim 9, further comprising instructions to modify said design based on said result step.

17. A data processing system having at least a processor and accessible memory to implement a method for design validation, comprising:
means for defining a plurality of requirements;
means for extracting said plurality of requirements;
means for comparing a design against said plurality of requirements; and
means for reporting a result of said comparison.
